(19) United States
(12) Patent Application Publication
(10) Pub. No.: US 2024/0377564 A1
(43) Pub. Date: Nov. 14, 2024

(54) Spectrally Selective Structured Materials

(71) Applicant: The Regents of the University of California, Oakland, CA (US)

(72) Inventors: Aaswath Pattabhi Raman, Los Angeles, CA (US); Jyotirmoy Mandal, Princeton, NJ (US)

(73) Assignee: The Regents of the University of California, Oakland, CA (US)

(21) Appl. No.: 18/052,415

(22) Filed: Nov. 3, 2022

Related U.S. Application Data
(60) Provisional application No. 63/263,533, filed on Nov. 4, 2021.

(51) Int. Cl. G02B 5/20; G02B 5/26

(52) U.S. Cl. CPC G02B 5/208; G02B 5/26; G02B 2207/101

(57) ABSTRACT

Filtering visible radiation from thermal radiation is valuable in decreasing noise in thermal imaging applications. The present disclosure relates to filter for filtering thermal radiation from a beam including both thermal radiation and visible radiation. A film made of particles with an average size and an average pore size is formed on a substrate. The average size and average pore size are greater than or equal to the wavelength of visible radiation but less than the wavelength of thermal or infrared radiation. Thus, in some cases, the film may be substantially transparent infrared radiation and substantially reflective or substantially absorptive to visible radiation. In other cases, the film may be substantially reflective to infrared radiation and substantially transparent or substantially absorptive to visible radiation.

### CROSS-REFERENCE TO RELATED APPLICATIONS

This application claims the benefit of and priority under 35 U.S.C. § 119 (e) to U.S. Provisional Patent Application Ser. No. 63/263,533, entitled “Spectrally Selective Structured Materials,” to Raman et al., filed Nov. 4, 2021, which is incorporated herein by reference in its entirety for all purposes.

### FIELD OF THE DISCLOSURE

The present invention generally relates to structured materials which selectively transmit or reflect certain radiation such as thermal infrared radiation.

### BACKGROUND

Thermal imaging, popularly known as heat vision, is an increasingly useful mode of sensing the environment around. All objects around radiate heat in varying extents, and the radiated heat can be used to detect, and image objects even in the absence of visible light. Besides offering the ability to “see in the dark,” thermal imaging also shows features that traditional photo/videography cannot see, e.g. a fault in building insulation that shows up as cold spots in thermographs, and skin temperatures of human beings. Given this, thermography has seen increasing uses in the following fields:
Medical diagnosis.
Autonomous vehicles—for sensing under low visibility, or invisible objects.
Defense/surveillance.
Quality control in industrial production lines.
Building insulation analysis.
Scientific research.
Meteorology—for studying the atmosphere and weather predictions.
Recreation.

In recent years, infrared (IR) optical systems have been increasingly used in imaging and sensing applications, as evidenced by a surge in demand for IR sensors. However, cost and ease of fabrication of germanium-based optical elements used in IR systems remains a major barrier to widespread adoption, particularly in low-resource settings.

### SUMMARY OF THE DISCLOSURE

Various embodiments relate to a spectrally selective optical filter that blocks solar radiation and transmits thermal radiation including: a film including nanostructures or microstructures with their sizes and materials optimized to scatter, reflect, or absorb more than 80% of one or more portions of the solar spectrum with a wavelength of 0.3-2.5 ∥m, and transmit more than 50% of one or more portions of the thermal radiation spectrum with a wavelength of 2.5-40 μm.

In various other embodiments, the film is formed on a substrate which is shaped in a lens or an optical flat.

In still various other embodiments, the film formed on the substrate focuses or concentrates thermal radiation onto a region for detection while diffusely scattering and diluting any solar radiation that is transmitted through.

In still various other embodiments, the film has no significant absorptance across one or more portions of the solar and thermal wavelengths and the film contains one or more of poly (ethene)/poly (ethylene) (PE), poly (vinylidene fluoride) (PVdF), zinc sulfide (ZnS), zinc selenide (ZnSe), sodium chloride (NaCI), and/or air in the form of pores.

In still various other embodiments, the average sizes of the nanostructures or microstructures are less than 1 μm.

In still various other embodiments, the film has a solar reflectance of greater than 0.8 and thermal transmittance of greater than 0.5.

In still various other embodiments, the film has no significant absorptance across one or more portions of the thermal wavelengths; the film has significant absorptance across one or more portions of the solar wavelengths; and the film contains one or more of copper oxide (CuO) and iron oxide (FeOₓ).

In still various other embodiments, the average sizes of the nanostructures or microstructures are less than 1 μm.

In still various other embodiments, the film has a solar absorptance greater than 0.8 and thermal transmittance greater than 0.6.

In still various other embodiments, the film is placed or coated on a thermally reflective substrate such that the film absorbs solar wavelengths and reflects thermal radiation.

In still various other embodiments, the thermally reflective substrate comprises a metal.

In still various other embodiments, the film and the substrate together are flat or have the curvature of a parabola, ellipse, or a sphere.

In still various other embodiments, the combined form of the film and substrate focuses or concentrates thermal radiation onto a region for detection, while diffusely scattering and diluting any solar radiation that is reflected off it.

Various further embodiments relate to a spectrally selective filter that absorbs solar radiation and reflects thermal radiation including: a film containing plasmonic metal nanoparticles with their sizes optimized to scatter, trap and strongly absorb one or more portions of the solar spectrum with of wavelength of 0.3-2.5 μm and substantially transmits one or more portions of the thermal radiation spectrum with a wavelength of 2.5-40 μm; and a metallic substrate underneath the film, which reflects back the thermal radiation transmitted by the film of plasmonic metal nanoparticles.

In various other embodiments, the metal substrate comprises copper, zinc, aluminum, iron, nickel, steel, or alloys.

In still various other embodiments, the plasmonic metal nanoparticles comprises at least one of copper, gold, silver, nickel, combinations thereof, or their respective oxides.

In still various other embodiments, the plasmonic metal nanoparticles have sizes between 5 nm and 1 μm.

In still various other embodiments, the plasmonic metal nanoparticles are arranged randomly, or hierarchically in random clusters, or in ordered formations.

In still various other embodiments, the film has a solar absorptance of 22 0.8 and thermal reflectance of >0.8.

In still various other embodiments, the combined form of the film and substrate is flat, or has the curvature of a parabola, ellipse or a sphere.

In still various other embodiments, the combined form of the film and substrate focuses or concentrates thermal radiation onto a region for detection, while diffusely scattering and diluting any solar radiation that is reflected off it.

Various further embodiments relate to an imaging system, which contains the filter described above as an optical component that guides light onto an imaging sensor.

Various further embodiments relate to a sensing system, which contains the filter described above as an optical component that guides light onto a detector.

Various further embodiments relate to an imaging system, which contains the filter described above as an optical component that reflects light onto an imaging sensor.

Various further embodiments relate to an sensing system, which contains the filter described above as an optical component that reflects light onto a detector.

In various other embodiments, the detector is placed at an appropriate distance from the filter to weaken the diffuse solar irradiance emerging from the filter and incident on the detector or sensor, while maintaining thermal radiation emerging from the filter on to the detector or sensor at high intensity.

In still various other embodiments, the film is made by sintering the nanostructures or microstructures in a mold.

In still various other embodiments, the film comprises polymers and air voids made using a foaming technique or phase inversion.

In still various other embodiments, the film is made by galvanic displacement, dealloying, or electrodeposition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 is a graph illustrating the influence of particle size in determines scattering.

FIG. 2 illustrates a schematic representation of the material of Configuration 1 interacting with radiation including sunlight and thermal radiation in accordance with an embodiment of the invention.

FIG. 3 illustrates an example graph of an example material of Configuration 1 showing measured optical performance.

FIG. 4A illustrates an example image of the example material of Configuration 1 as imaged from a camera capturing visible light.

FIG. 4B illustrates an example image of the example material of Configuration 1 as imaged from an IR camera.

FIG. 5 illustrates a schematic representation of the material of Configuration 2 interacting with radiation including sunlight and thermal radiation in accordance with an embodiment of the invention.

FIG. 6A illustrates an example image of the material of Configuration 2 as imaged from a camera capturing visible light.

FIG. 6B illustrates an example image of the example material of Configuration 1 as imaged from an IR camera.

FIG. 7A illustrates the general functionality of the material of Configurations 3 or 4.

FIG. 7B illustrates a schematic of the general functionality of the material of Configuration 3 or 4 showing a plasmonic nanostructure coated metal substrate that acts as a selective reflector of thermal infrared (TIR) radiation.

FIG. 8 is a graph illustrating an example of Configuration 4 which involves solar or sunlight absorption.

FIG. 9A is an example image of the material of Configuration 4 coated on a metal substrate as imaged from a camera capturing visible light.

FIG. 9B is an example image of the material of Configuration 4 as imaged from an IR camera.

FIG. 10A is an example image of Twymann-green interferometry used on a reference mirror which shows sharp interference fringes which is indicative of a high optical flatness and high surface smoothness.

FIG. 10B is an example image of Twymann-green interferometry used on the material of Configuration 4 coated on a metal substrate.

FIGS. 11A and 11B illustrate two example schematics of implementations of Configuration 3 and Configuration 4.

FIGS. 12A and 12B conceptually illustrate an example sintering process.

FIG. 13A illustrates an example of a galvanic displacement process.

FIG. 13B is a scanning electron micrograph showing copper nanoparticles, with large 200 nm clusters made from smaller nanostructure which are produced utilizing the galvanic displacement process described in connection with FIG. 13A.

FIG. 14 illustrates an example of the galvanic displacement process of FIG. 13A with a mechanical vibration provided by a mechanical vibrator.

FIG. 15 illustrates an example dealloying process to create plasmonically nanostructured particles on a metal substrate.

FIG. 16 illustrates an example electrodeposition process to create plasmonically nanostructured metal or their oxides on a metal substrate.

### DETAILED DESCRIPTION

At present, major consumer grade thermal cameras use germanium-based optics coupled with microbolometer array sensors. While the germanium-based optical components may allow for good imaging capability, they have some major disadvantages:
Germanium, a semiconductor with a band gap of 0.66 eV (corresponding to a wavelength of 1.87 μm), transmits sunlight between 1.87 and 2.5 μm, which accounts for ˜4% of sunlight. Therefore, that portion of sunlight reflecting off objects to be thermally imaged is still seen by sensors, and counts as noise.
Germanium has a high refractive index, which leads to low infrared transmittance.
Germanium is also very expensive as a material. Thus, germanium-based optics are very expensive—a lens the size of those in modern DSLR cameras can cost upwards of $5,000. This makes thermal cameras prohibitively expensive.
Germanium is brittle, and difficult to machine onto lenses and mirrors.
Germanium suffers from thermal darkening, i.e. at temperatures above 65° C., it becomes opaque to infrared, meaning that germanium-based optics cannot be used in high temperature systems.

To compensate for germanium's shortcomings, germanium has been coated with precise thicknesses or filters are placed in front of the sensor, however, such filters are expensive. For these reasons, alternative optical materials are being increasingly sought after by the thermal imaging industry.

### Effective Material for Use in Thermal Imaging System

Embodiments of the present disclosure include one or more of the following properties:
Transparent to thermal radiation (2.5-40 μm wavelengths, and more specifically 8-13 μm where the atmosphere is transmissive).
Absorptive or reflective to undesirable wavelengths that counts as noise, e.g. sunlight (0.3-2.5 μm wavelengths).
Inexpensive and easily replaceable.
Easy to machine/fabricate into optical components.
Suitable for use at high or low temperatures.
Low cost: in light of the surge in demand for the recent surge in thermal imaging devices for medical screening, and an anticipated surge in demand by the autonomous vehicle industry, low-cost thermal imagers are becoming increasingly important.

Some embodiments may include spectrally selective plasmonic surfaces which may be scalable and low-cost IR optical components that absorb ultraviolet-to-short wavelength IR radiation, while showing a specular behavior in the longer infrared wavelengths. These surfaces can be conveniently manufactured at large scales, and alone or in combination with other materials, used as reflective or transmissive IR optical components.

In some embodiments, finite-difference time-domain (FDTD) simulation results may be used to model the spectrally selective plasmonic surfaces. Experimental demonstrations of the optical capability (e.g. selectivity and integrability into optical systems) using specific plasmonic designs are disclosed herein.

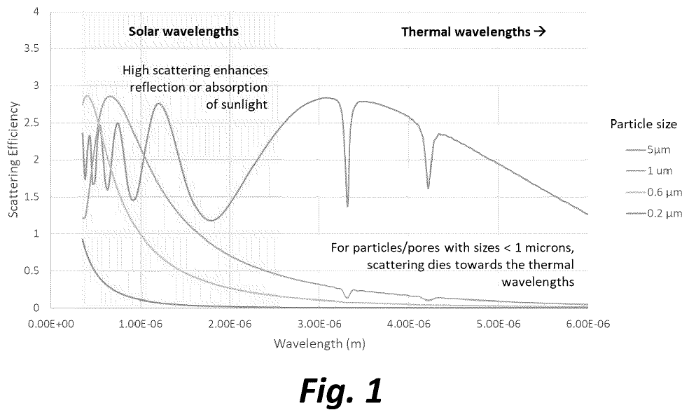

Turning now to the figures, FIG. 1 is a graph illustrating the influence of particle size in determines scattering, which in turn determines how they behave differently towards sunlight and thermal radiation. High scattering can enhance absorption and reflection of unwanted sunlight, while low scattering in the thermal wavelengths allows thermal radiation to pass through onto detectors, or be selectively reflected by an underlying metal substrate. As illustrated, lower particle size with sizes <1 microns, scattering dies towards the thermal wavelengths.

Example configurations are provided below:

Configuration 1: a material, which is intrinsically (e.g. in its bulk form) transparent across one or more portions of the thermal wavelengths (2.5-40 μm), and transparent in one or more portions of the solar wavelengths. By structuring this material into particles (or a porous form) with sizes 0.05-1 μm (similar to solar wavelengths), a film of such particles (or porous material) can be made to strongly scatter and reflect solar wavelengths. Therefore, sunlight or visible light (0.3-2.5 μm wavelengths) does not pass through. However, the longer thermal radiation wavelengths are much larger than the particle sizes, and are thus not scattered. Consequently, they pass straight through the material in a specular manner, and can be imaged by a sensor.

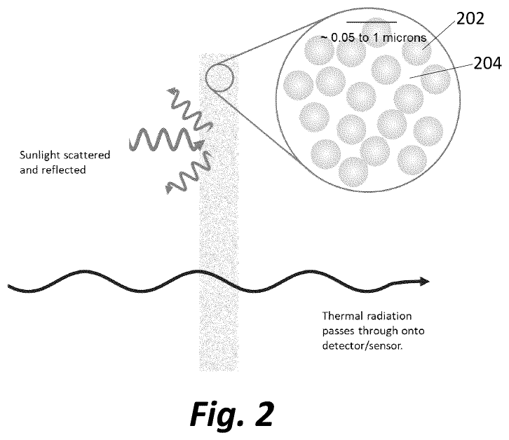

FIG. 2 illustrates a schematic representation of the material of Configuration 1 interacting with radiation including sunlight and thermal radiation in accordance with an embodiment of the invention. As illustrated, Configuration 1 includes intrinsically transparent material structured into nano-scale porous or particulate form to scatter and reflect sunlight, while letting thermal radiation pass. The nano-scale particles 202 or pores 204 scatter and reflect sunlight but let thermal radiation pass.

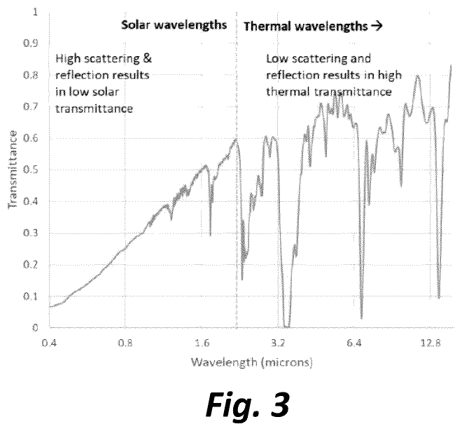

FIG. 3 illustrates an example graph of an example material of Configuration 1 showing measured optical performance. With solar radiation wavelengths, high scattering and reflection results in low solar transmittance. Whereas, with thermal radiation wavelengths, low scattering and reflection results in high thermal transmittance. The material of Configuration 1 may be a porous polyethene film.

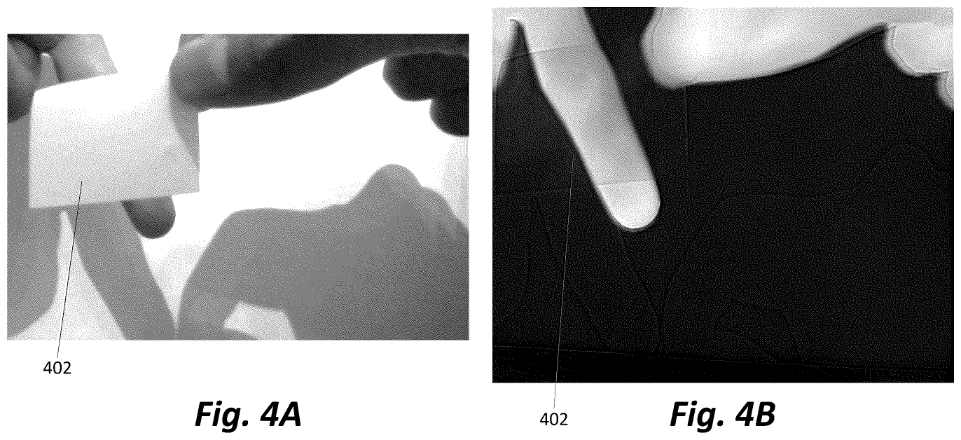

FIG. 4A illustrates an example image of the example material 402 of Configuration 1 as imaged from a camera capturing visible light. FIG. 4B illustrates an example image of the example material 402 of Configuration 1 as imaged from an IR camera. As illustrated, the example material 402 is opaque to visible light whereas the example material 402 is substantially transparent to infrared radiation.

Configuration 2: the material of Configuration 1 may be intrinsically absorptive in one or more parts of the solar wavelengths. In that case, scattering by the nanoparticles or pores leads to absorption of solar wavelengths, preventing those from reaching the sensor. Thermal radiation, however, passes through.

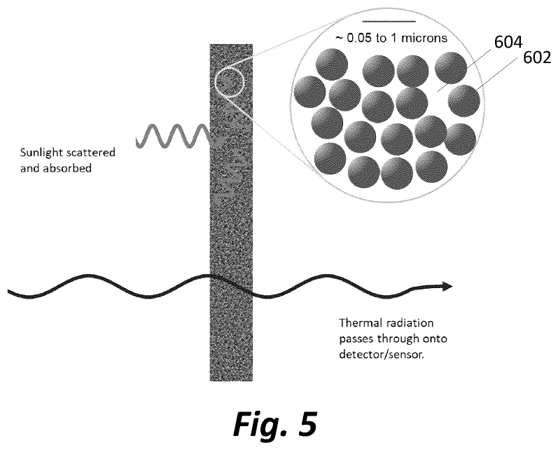

FIG. 5 illustrates a schematic representation of the material of Configuration 2 interacting with radiation including sunlight and thermal radiation in accordance with an embodiment of the invention. The film may be intrinsically solar-absorptive but thermally transparent material structured into nano-scale porous or particulate form to scatter and absorb sunlight, while letting thermal radiation pass. Nano-scale particles 602 or pores 604 scatter and absorb sunlight but let thermal radiation pass.

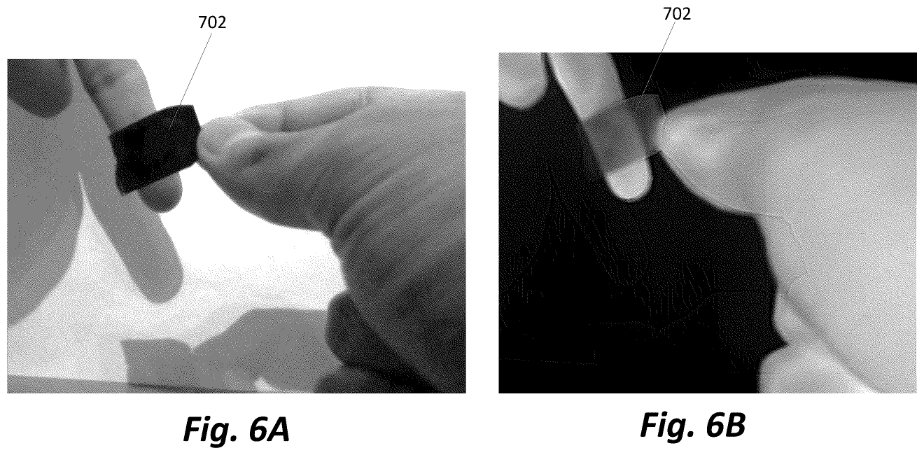

FIG. 6A illustrates an example image of the material 702 of Configuration 2 as imaged from a camera capturing visible light. FIG. 6B illustrates an example image of the example material 702 of Configuration 1 as imaged from an IR camera. As illustrated, the example material 702 is opaque to visible light whereas the example material 702 is substantially transparent to infrared radiation. The example material of Configuration 2 may be black pigmented polyethene.

In these configurations, the material of Configuration 1 or Configuration 2 may be used as transmission optics for imaging systems (e.g. windows and lenses).

Configuration 3: the material of Configurations 1 or 2 may be coated or placed on metal (which is an excellent reflector of infrared wavelengths) to make them reflect thermal radiation, while absorbing sunlight.

Configuration 4: the material of Configurations 1 or 2 may be plasmonic metal nanoparticles on a metal substrate. Plasmonic nanoparticles selectively absorb sunlight but only weakly absorb thermal wavelengths. By depositing a film of plasmonic nanoparticles on metal, the combined structure can be made into a selective mirror for thermal infrared radiation, and absorber for sunlight.

The material of Configurations 3 or 4 may be used as reflection optics for imaging systems (e.g. flat, parabolic, or spherical mirrors).

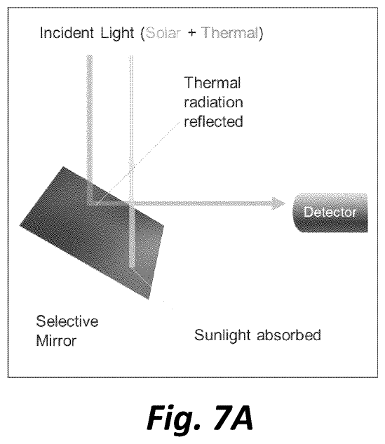

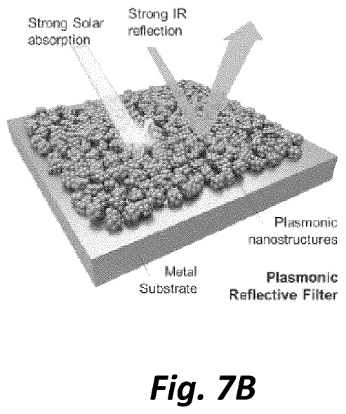

FIG. 7A illustrates the general functionality of the material of Configurations 3 or 4 which involves placing one of the materials of Configuration 1 or Configuration 2 on a thermally reflective metal substrate to produce a selective thermal reflector. One of the materials of Configuration 1 or Configuration 2 placed on a metal substrate creates a mirror that absorbs sunlight and reflects thermal radiation.

FIG. 7B illustrates a schematic of the general functionality of the material of Configuration 3 or 4 showing a plasmonic nanostructure coated metal substrate that acts as a selective reflector of thermal infrared (TIR) radiation.

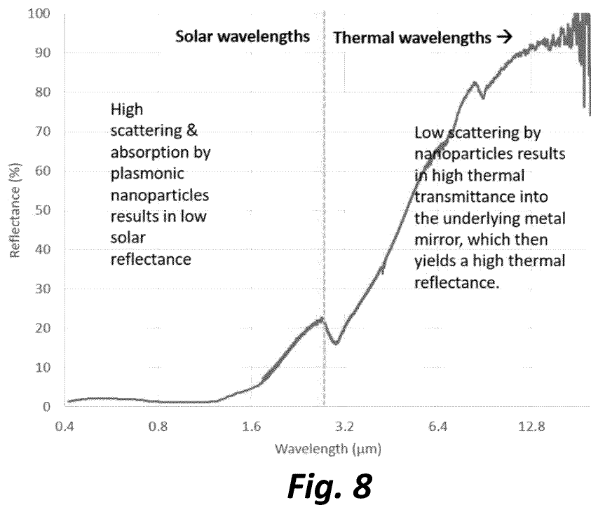

FIG. 8 is a graph illustrating an example of Configuration 4 which involves solar or sunlight absorption. Thermal or infrared transparent plasmonic nanoparticle film on metal creates a mirror that absorbs sunlight, but reflects thermal radiation.

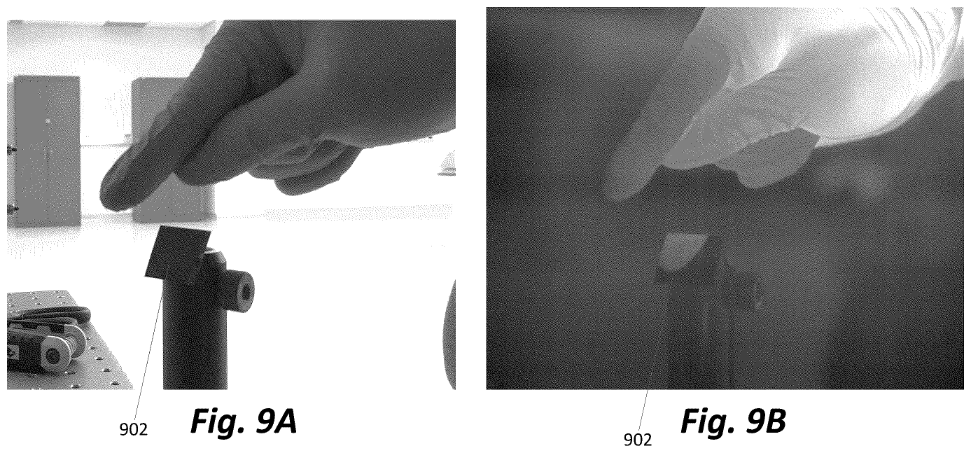

FIG. 9A is an example image of the material of Configuration 4 coated on a metal substrate as imaged from a camera capturing visible light. FIG. 9B is an example image of the material 902 of Configuration 4 as imaged from an IR camera. As illustrated, the example material 902 absorbs visible light whereas the example material 902 is substantially reflective to infrared radiation. The example material of Configuration 4 may include a plasmonic nanoparticle metal film.

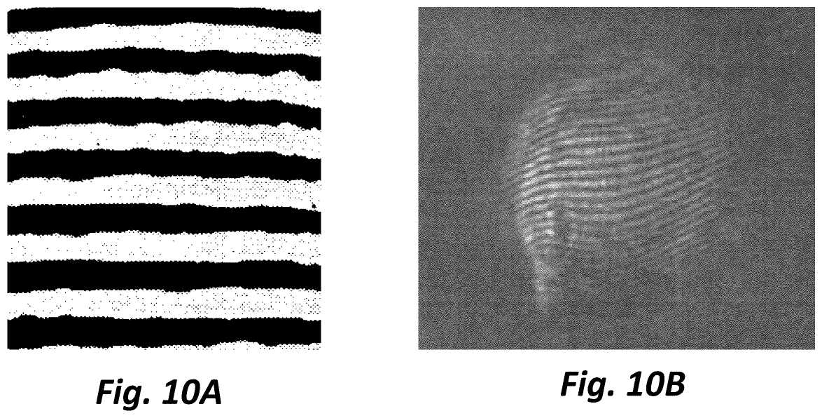

In some embodiments, the material of Configuration 3 or Configuration 4 coated on a metal substrate exhibits high optical flatness or surface smoothness. Twymann-green interferometry may be used to check the surface smoothness of the material. FIG. 10A is an example image of Twymann-green interferometry used on a reference mirror which shows sharp interference fringes which is indicative of a high optical flatness and high surface smoothness. FIG. 10B is an example image of Twymann-green interferometry used on the material of Configuration 4 coated on a metal substrate. The material has the same sharp interference fringes which indicates that the material has a high optical flatness and high surface smoothness. Thus, the material of

Configuration 4 coated on a metal substrate is a smooth surface which may aid in reflection of thermal radiation.

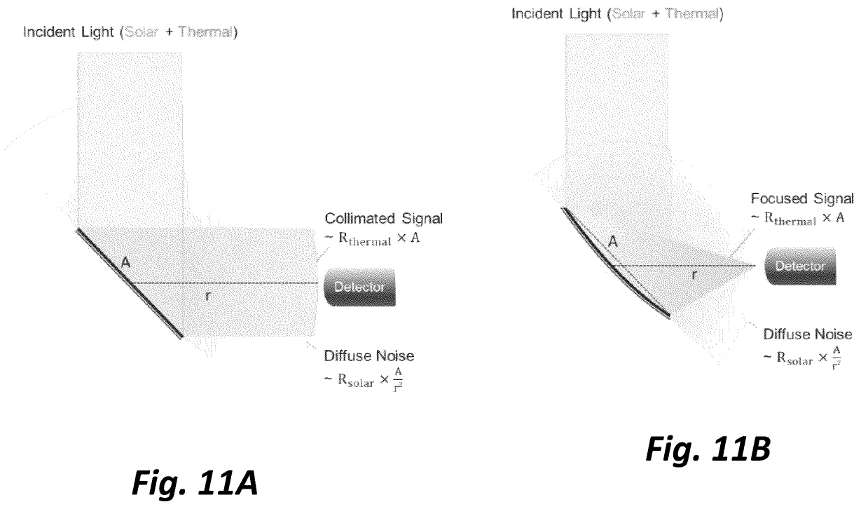

FIGS. 11A and 11B illustrate two example schematics of implementations of Configuration 3 and Configuration 4. FIG. 11A illustrates a flat mirror design, whereas FIG. 11B illustrates a curved mirror design. As illustrated, the curved mirror design of FIG. 11B focuses the thermal radiation which may increase signal. Also, the detector may be placed further from the mirror to reduce noise in the form of diffusely reflected sunlight.

### Example Effective Materials

Broadly speaking, nanostructured variants of materials which are transparent across the solar and thermal wavelengths, or more absorptive in the solar than in the thermal wavelengths can be used. These materials can include (without limitation):
Nanoparticles or porous variants of one of poly(ethene)/poly(ethylene) (PE), poly(vinylidene fluoride) (PVdF) and variants, zinc sulfide (ZnS), zinc selenide (ZnSe), sodium chloride (NaCl), copper oxide (CuO) and iron oxide (FeOx).
Nanostructured copper (n-Cu), nanostructured silver (n-Ag), nanostructured nickel (n-Ni), among other metals.

By themselves, these materials may be used to make the materials of any one of Configurations 1 or Configuration 2. These materials may be placed on a smooth metal substrate to create Configuration 3 or Configuration 4.

### Example Structure and Fabrication

The material of Configurations 1-4 may be small nanoparticles or microparticles of the above materials formed into sheets or curved surfaces.

In some embodiments, the material of Configurations 1-4 may be formed by sintering particles and molding into shape using traditional thermal techniques. For certain polymeric materials, this can be achieved by using foaming or phase inversion techniques to create porous polymers, followed by thermal molding into shape. For plasmonic particles on metal, this can be made by electrodeposition-based, galvanic-displacement based techniques and dealloying-techniques. Some of these techniques may be used at large scales to make variants of the above configurations.

In some embodiments, small non-metal nanoparticles or microparticles may be produced through ball-milling.

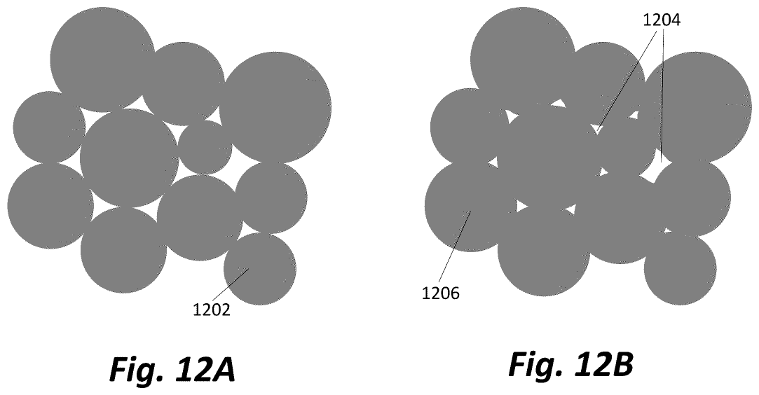

To produce a coating out of nanoparticles or microparticles, a sintering process may be used. FIGS. 12A and 12B conceptually illustrate an example sintering process. FIG. 12A illustrates the particles prior to the sintering process. The particles 1202 may be placed within a mold. During the sintering process, the mold may be subjected to a pressure and a temperature. The pressure may be above atmospheric pressure and the temperature may be above room temperature. FIG. 12B illustrates the particles after the sintering process. As illustrated, the sintered particles 1206 may include gaps 1204. Sintering may reduce the gaps 1204 between the sintered particles 1206 which decreases the size of the micro or nanopores which may increase reflected sunlight or absorbed sunlight.

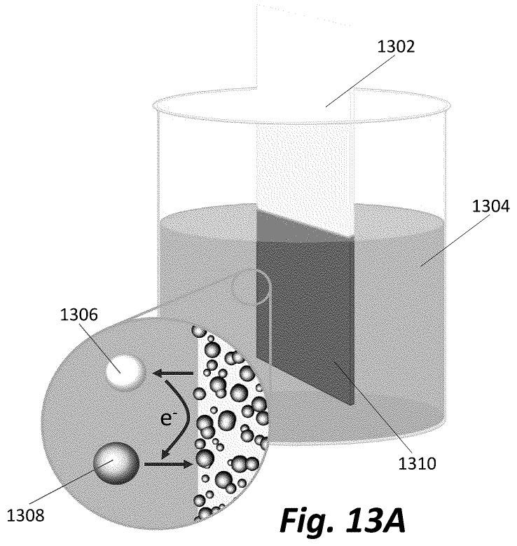

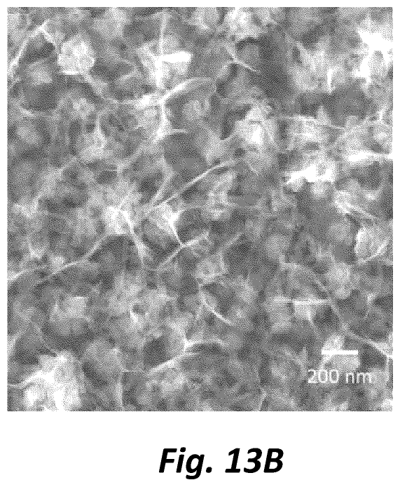

For producing metallic particles, a galvanic displacement process may be used. FIG. 13A illustrates an example of a galvanic displacement process. A metal substrate 1302 may be provided. The metal substrate 1302 may include a first metal. The metal substrate 1302 is submerged into a salt solution 1304. The salt solution 1304 may include ions of a second metal. The inset image illustrates an ion exchange process which produces nanoparticles. In the ion exchange process, the ions of the second metal may ionize the first metal to produce first metal ions 1306. Second metal ions 1308 in the salt solution 1304 deposit on the surface of the metal substrate 1302 to form a coating 1310 of nanoparticles of an alloy of the first metal and the second alloy. For the case of Configurations 3 or 4 where particles are to be formed on a metal substrate (see description above), the nanoparticles may be left on the metal substrate 1302 to form the material of Configurations 3 or 4 coated on the metal substrate 1302.

In some embodiments, the metal substrate 1302 may be a zinc strip. The salt solution 1304 may be an aqueous copper sulfate which may produce copper nanoparticles on the zinc strip. The nanoparticles may cluster with sizes 200 nm and features <50 nm in size, indicating that the underlying zinc may play a major role in thermal infrared reflection.

FIG. 13B is a scanning electron micrograph showing copper nanoparticles, with large 200 nm clusters made from smaller nanostructure which are produced utilizing the galvanic displacement process described in connection with FIG. 13A.

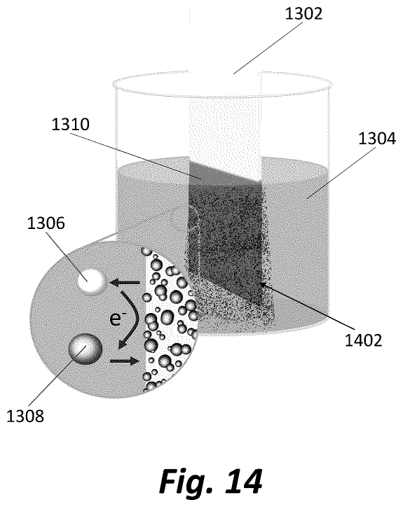

FIG. 14 illustrates an example of the galvanic displacement process described in connection with FIG. 13A with a mechanical vibration provided by a mechanical vibrator such as an ultra-sonicator. The mechanical vibration may dislodge the nanoparticles 1402 from the coating 1310 on the metal substrate 1302 which may remain within the salt solution 1304. The nanoparticles 1402 may be extracted from the salt solution 1304. Additionally, where applicable, second metal plasmonic particles on the metal substrate 1302 can be heated to create solar absorbing black oxide layers, such as copper oxide or iron oxide.

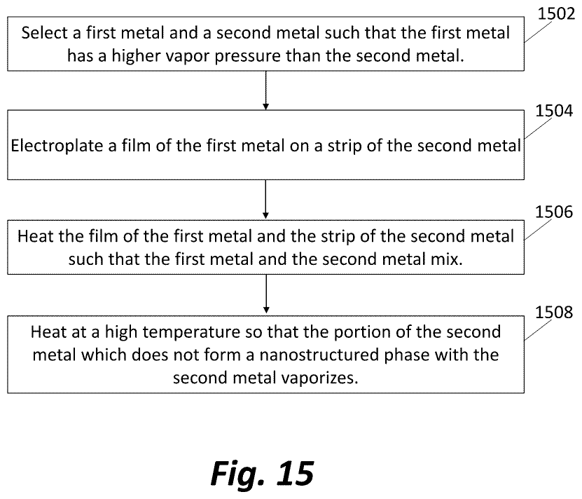

In some embodiments, to form plasmonically nanostructured particles (Configuration 4) on a metal substrate, a dealloying process may further be used. FIG. 15 illustrates an example dealloying process to create plasmonically nanostructured particles on a metal substrate. The process includes selecting (1502) a first metal and a second metal. The first metal may have a higher vapor pressure than the second metal. The first metal and the second metal may form an alloy. The process further includes electroplating (1504) a film of the first metal onto a strip of the second metal. The process further includes heating (1506) the film of the first metal and the strip of the second metal such that the first metal and the second metal mix. The first metal may form a nanostructured phase on the surface of the strip of the second metal. The heating may occur at a fairly low temperature. This temperature may be lower than the vaporation temperature of the first metal. The process further includes further heating (1508) the first metal and the second metal at a high temperature so that the portion of the first metal which does not form a nanostructured phase with the second metal vaporizes. The portion of the first metal which does not alloy with the second metal vaporizes and thus what remains is the alloy of the first metal and the second metal. The network of nanoparticles connect to each other which bonds the first metal to the second metal.

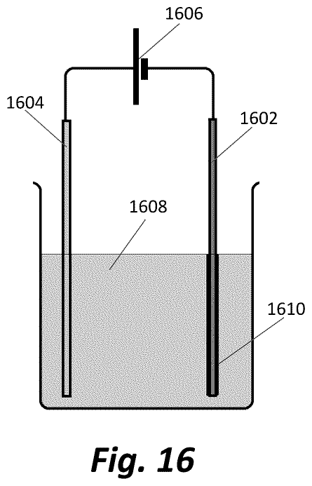

In some embodiments, to form plasmonically nanostructured metal (Configuration 4) or their oxides on a metal substrate, an electrodeposition process may be used. FIG. 16 illustrates an example electrodeposition process to create plasmonically nanostructured metal or their oxides on a metal substrate. The metal substrate 1602 may be utilized as an anode. The metal substrate 1602 may include one or more metals such as (but not limited to) aluminum, anodized aluminum, copper, or steel. A counter electrode 1604 is electrically connected to the metal substrate 1602 through wiring. A bias may be applied through the counter electrode 1604 and the metal substrate 1602. The counter electrode 1604 and the metal substrate 1602 may be connected to a DC voltage source 1606. The counter electrode 1604 and the metal substrate 1602 may be submerged in a electrolyte 1608. The electrolyte 1608 may contain an aqueous metal solution or metal oxide solution. For example, the electrolyte 1608 may contain, without limitation, one or more of aqueous nickel sulfate or chromium (III) oxide. As a result of the electrodeposition, the metal substrate 1602 may be coated with a metallic coating 1610. The metal coating 1610 may be a nanostructured metal or metal oxide. For example, the metal coating 1610 may include nickel nanostructures or chromium oxide nanostructures, which may selectively absorb sunlight but let thermal radiation pass and be reflected by the underlying metal substrate 1602.

While specific example processes have been discussed above, a skilled artisan would understand that other processes may be used to create the material of Configurations 1-4 such as other processes for making particles.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A spectrally selective optical filter that blocks solar radiation and transmits thermal radiation comprising:
a film comprising nanostructures or microstructures with their sizes and materials optimized to scatter, reflect, or absorb more than 80% of one or more portions of the solar spectrum with a wavelength of 0.3-2.5 μm, and transmit more than 50% of one or more portions of the thermal radiation spectrum with a wavelength of 2.5-40 μm.

2. The filter of claim 1, wherein the film is formed on a substrate which is shaped in a lens or an optical flat.

3. The filter of claim 2, wherein the film formed on the substrate focuses or concentrates thermal radiation onto a region for detection while diffusely scattering and diluting any solar radiation that is transmitted through.

4. The filter of claim 1, wherein the film has no significant absorptance across one or more portions of the solar and thermal wavelengths and the film contains one or more of poly(ethene)/poly(ethylene) (PE), poly(vinylidene fluoride) (PVdF), zinc sulfide (ZnS), zinc selenide (ZnSe), sodium chloride (NaCl), and/or air in the form of pores.

5. The filter of claim 4, wherein the average sizes of the nanostructures or microstructures are less than 1 μm.

6. The filter of claim 4, wherein the film has a solar reflectance of greater than 0.8 and thermal transmittance of greater than 0.5.

7. The filter of claim 1, wherein:
the film has no significant absorptance across one or more portions of the thermal wavelengths;
the film has significant absorptance across one or more portions of the solar wavelengths; and
the film contains one or more of copper oxide (CuO) and iron oxide (FeOₓ).

8. The filter of claim 7, wherein the average sizes of the nanostructures or microstructures are less than 1 μm.

9. The filter of claim 7, wherein the film has a solar absorptance greater than 0.8 and thermal transmittance greater than 0.6.

10. The filter of claim 7, wherein the film is placed or coated on a thermally reflective substrate such that the film absorbs solar wavelengths and reflects thermal radiation.

11. The filter of claim 10, wherein the thermally reflective substrate comprises a metal.

12. The filter of claim 10, wherein the film and the substrate together are flat or have the curvature of a parabola, ellipse, or a sphere.

13. The filter of claim 12, wherein the combined form of the film and substrate focuses or concentrates thermal radiation onto a region for detection, while diffusely scattering and diluting any solar radiation that is reflected off it.

14. A spectrally selective filter that absorbs solar radiation and reflects thermal radiation comprising:
a film containing plasmonic metal nanoparticles with their sizes optimized to scatter, trap and strongly absorb one or more portions of the solar spectrum with of wavelength of 0.3-2.5 μm and substantially transmits one or more portions of the thermal radiation spectrum with a wavelength of 2.5-40 μm; and
a metallic substrate underneath the film, which reflects back the thermal radiation transmitted by the film of plasmonic metal nanoparticles.

15. The filter of claim 14, wherein the metal substrate comprises copper, zinc, aluminum, iron, nickel, and/or steel.

16. The filter of claim 14, wherein the plasmonic metal nanoparticles comprises at least one of copper, gold, silver, nickel, and/or their respective oxides.

17. The filter of claim 14, wherein the plasmonic metal nanoparticles have sizes between 5 nm and 1 μm.

18. The filter of claim 14, wherein the plasmonic metal nanoparticles are arranged randomly, or hierarchically in random clusters, or in ordered formations.

19. The filter of claim 14, wherein the film has a solar absorptance of greater than 0.8 and thermal reflectance of greater than 0.8.

20. The filter of claim 14, where the combined form of the film and substrate is flat, or has the curvature of a parabola, ellipse or a sphere.
